(19) United States
(12) Patent Application Publication
(10) Pub. No.: US 2003/0142122 A1
(43) Pub. Date: Jul. 31, 2003

(54) Method, apparatus, and system for replaying data selected from among data captured during exchanges between a server and a user

(76) Inventors: Christopher Straut, Duluth, GA (US); Albert S. Boyers, Atlanta, GA (US); Joseph H. Owen JR., Douglasville, GA (US); Ram Choragudi, Alpharetta, GA (US)

Correspondence Address: NEEDLE & ROSENBERG, P.C., Suite 1200, The Candler Building, 127 Peachtree Street, N.E, Atlanta, GA, 30303-1811, US

(21) Appl. No.: 10/061,491

(22) Filed: Jan. 31, 2002

(51) Int. Cl. G09G 5/00

(52) U.S. Cl. 345/704; 345/745

(57) ABSTRACT

Data selected from among data captured during at least one interaction between at least one server and at least one user is replayed. The captured data is collected during a given time period, and a session of interactions between the server and the user is assembled in the order in which they occurred. Then, the session is replayed. Data that satisfies predetermined search criteria may be searched for among the captured data, a result set of data satisfying the search criteria may be created, and the session may be assembled from the result set. The data may be searched based upon predefined rules. The search criteria may be specified by the user and may include a date and time range or a specific user. The captured data may be searched sequentially. The user may be a web server or a web browser, and the server may be a web server. The captured data may be in the form of an Internet protocol, and the session may be displayed as at least one web page to the user. Data captured during interactions between a plurality of servers and the user, the server and a plurality of users, or a plurality of servers and a plurality of users may be replayed.

### CROSS REFERENCE TO RELATED APPLICTIONS

This application is related to commonly assigned U.S. Patent Applications entitled “Method, Apparatus, and System for Capturing Data Exchanged Between a Server and a User” and “Method, Apparatus, and System for Processing Data Captured During Exchanges Between a Server and a User”, filed on or about the same day as the present application and incorporated herein by reference.

### BACKGROUND

The present invention is directed to a method, apparatus, and system for playing selected data. More particularly, the present invention is directed to a method, apparatus, and system for replaying data selected from among data captured during an exchange between a server and a user.

For systems employing interactions between a user and server, it is often desirable to be able to view the interactions, ideally in a manner that is transparent to the user. This is particularly desirable in a context such as sales, customer service, and e-commerce, where interactions between customers and a service provider are important indicators of customer satisfaction.

Attempts have been made to recreate interactions between a user and a server. For example, click stream analysis procedures have been used to recreate interactions between a web user and a web service provider. This type of procedure is analogous to reviewing and analyzing the script to a movie. While this procedure reveals some information about the interaction between the server and the user, it does not provide a clear tangible picture of special effects, the environment, chemistry between the user and the server, etc.

Other attempts have been made to replay recorded interactions between a server and a user. However, these attempts are typically implemented at the server and are thus suitable only for a particular type of server. In addition, these approaches typically do not distinguish between interactions that are considered important and interactions that are not important. Thus, a lot of time and resources are wasted on replaying unimportant recorded interactions.

There is thus a need for a technique replaying data selected from among data captured during exchanges between and a web server and a user.

### SUMMARY

The present invention is directed to a method, apparatus and system replaying data captured during at least one interaction between at least one server and at least one user data selected from among data captured during an exchange between a web server and a user.

According to exemplary embodiments, data captured during the interaction between the server and the user during a given time period is collected. A session of interactions between the server and the user, including the at least one interaction, is assembled in the order in which they occurred. Then, the session is replayed.

According to one embodiment, data that satisfies predetermined search criteria is searched for among the captured data, and a result set of data satisfying the search criteria is created. The session is assembled from the result set. The data may be searched based upon predefined rules. The search criteria may be specified by the user and may include a date and time range or a specific user. The captured data may be searched sequentially.

According to one embodiment, the user is a web server or a web browser, and the server is a web server. The data captured may include pages, events, and attributes. The captured data may be in the form of an Internet protocol, and the session is displayed as at least one web page to the user.

According to exemplary embodiments, data captured during interactions between a plurality of servers and the user, the server and a plurality of users, or a plurality of servers and a plurality of users may be replayed.

Further objects, advantages and features of the present invention will become more apparent when reference is made to the following description taken in conjunction with the accompanying drawings.

### BRIEF DESCRIPTION OF THE DRAWINGS

FIG. 1 illustrates an exemplary system for capturing, recording, and playing back data according to an exemplary embodiment;

FIGS. 2A-2C illustrate exemplary search pages;

FIGS. 3A-3G illustrate an exemplary playback page; and

FIG. 4 illustrates an exemplary method for playing data according to an exemplary embodiment.

### DETAILED DESCRIPTION

According to exemplary embodiments, data exchanged between a server and a user that is selectively recorded is played back. In the following description, the server is referred to as a web server, and the user is referred to as a web browser. It will be appreciated, however, that the invention may be applicable to other types of servers and users.

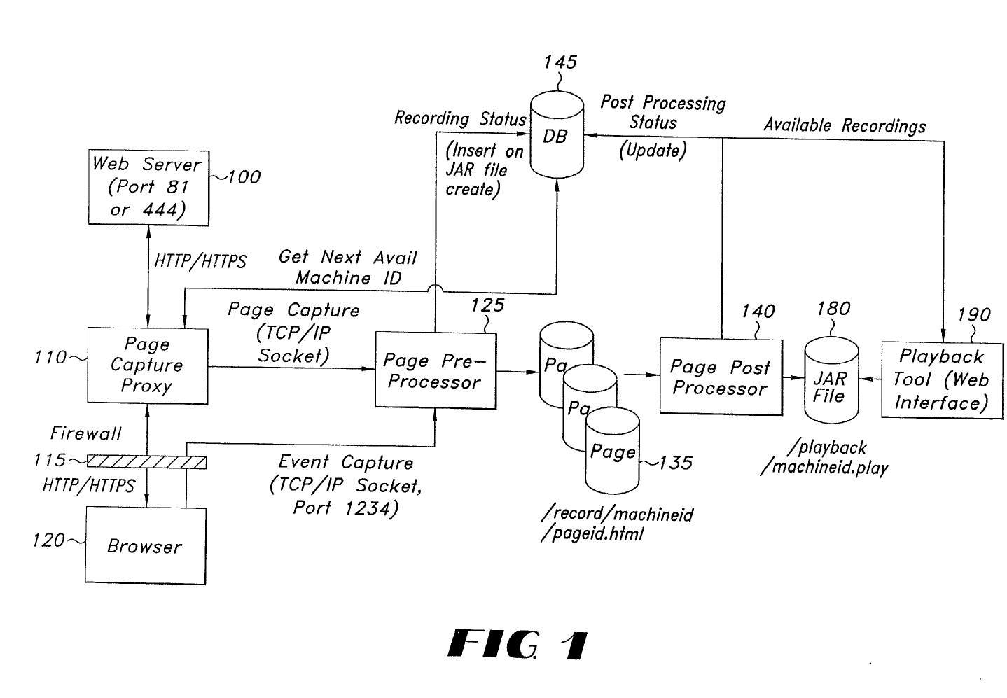

FIG. 1 illustrates an exemplary system for capturing, recording, and playing data in which the invention may be implemented. The system includes a server, such as a web server 100, a data capturing module, such as a page capture module 110, and a user, such as a web browser 120.

Although only one web server 100, page capture module 110, and web browser 120 are depicted in FIG. 1, it will be appreciated that the invention is applicable to any number of servers, data capturing modules, and users.

The web browser 120 may be implemented in a personal computer, a telephone, etc. The web server 100 may be implemented as a server supporting any operating system, e.g., Unix, Linux, NT or Windows 2000.

The page capture module 110 is arranged between the web server 100 and the web browser 120. For security purposes, a firewall 115 may separate the web browser 120 and the page capture module 110.

The page capture module 110 operates independently from the web server 100 and the web browser 120. Thus, the page capture module 110 does not need to be customized for each type of web server but may be used with any web server, supporting any operating system.

Although the page capture module 110 operates independently from the web server 100 and the web browser, it may be implemented in the same device as the web server 100 or the web browser 120.

The page capture module 110 captures pages and other data exchanged between the web server 100 and the browser 120. Pages and other data may be captured continually or at designated intervals or time windows. The page capture module 110 may also record these pages and other data, or recording may be performed in a separate recorder server connected to the page capture module.

Each web browser 120 is assigned a unique machine identity (ID) by the web server 100. A persistent machine ID cookie may be created by the web server 110 and stored at the web browser 120 for this purpose. All pages served to a particular web browser 120 are identified and grouped by the machine ID.

Although the module 110 is described as a page capture module, according to exemplary embodiments, other types of data may also be captured. For example, events and attributes may be captured. Attributes may be captured in a manner similar to that in which pages are captured, as described above.

For event capturing, according to an exemplary embodiment an event capture module captures user side events and delivers these to the page capture module 110. The event capture module may be implemented as an applet 130 that is downloaded to the web browser 120. Although shown as a separate component, the event capture applet 130 is stored at the browser, with parameters such as the web browser machine ID, the host Internet Protocol (IP) address, and the current page name. The event capture applet 130 may be notified, for example, by JavaScript embedded in the current page, whenever an event needs to be recorded. The event capture applet 130 records events such as: page load, page unload, page scroll, page resize, and browser exit. The event capture applet 130 sends captured events to the page capturing module 110 via, for example, a Transmission Control Protocol/Internet Protocol (TCP/IP) socket connection on port 80 (or port 443 for secure exchanges).

Pages and other data captured during exchanges between the web server 100 and the web browser 120 at the page capture module 110 are sent from the page capturing module 110 to a page preprocessor 125 via, e.g., a TCP/IP socket.

According to an exemplary embodiment, each captured page is assigned a unique page ID and is associated with a specific browser user machine ID. Each page may also contain the date and time that the page was captured and the page status (recording, processing, playback, etc.) After pages are captured, this information is extracted from the captured page, and a new record is inserted into a database 145.

The page preprocessor 125 acts as a recorder server and stores the captured data in a device such as a database 145. The pages 135 are then passed on to the page post-processor 140. Alternatively, the page capturing module 110 may perform this recording. To reduce the amount of storage necessary, only predetermined portions of data may be stored, e.g., the request portion or the response portion. Also, only data satisfying predetermined rules, e.g., rules indicating timing, may be stored. When the captured pages are recorded, identifying information may also be recorded, e.g., a session record ID, a date/time of recording, a machine ID, etc.

An exemplary page capturing module and page preprocessor are described in more detail in the afore-mentioned application entitled “Method, Apparatus, and System for Capturing Data Exchanged Between a Server and a User”.

A post-processing module 140 determines which captured data satisfies predefined rules, e.g., business rules, and records this data in a playback database 180, such as a JAR file. The database 145 is updated to indicate what captured data has been selected and recorded for playback. Captured and recorded pages, attributes, and events are fed to a page post-processing program running on a processor 140. A business rules engine 150 delivers business rules to the post-processor that evaluates the captured/recorded pages to determine whether they satisfy the business rules. Data from a page table database 160 and a page rule table database 170 is used during this evaluation. Pages that satisfy the business rules are recorded for future playback. An exemplary post-processor is described in more detail in the afore-mentioned application entitled “Method, Apparatus, and System for Processing Data Captured During Exchanges Between a Server and a User”.

A playback tool 190 selects recorded data from the database 180, using the information in the database 145. The playback module 190 controls playback of the data. The data may be displayed, for example, in a search frame for the web server or the browser.

Although not shown in the interest of simplifying the illustrations, it will be appreciated that the system in FIG. 1 may also include other components, e.g., configuration files used for processing and log files use for storing information for debugging, etc.

According to an exemplary embodiment, a user is allowed to search for, select and playback a recorded browser session using the playback module 190. The playback module 190 assembles a session of recordings selected by the user and plays back the session. The playback module may be implemented using, e.g., Netscape 4.5x and above browser or an Internet Explorer 4.x and above browser.

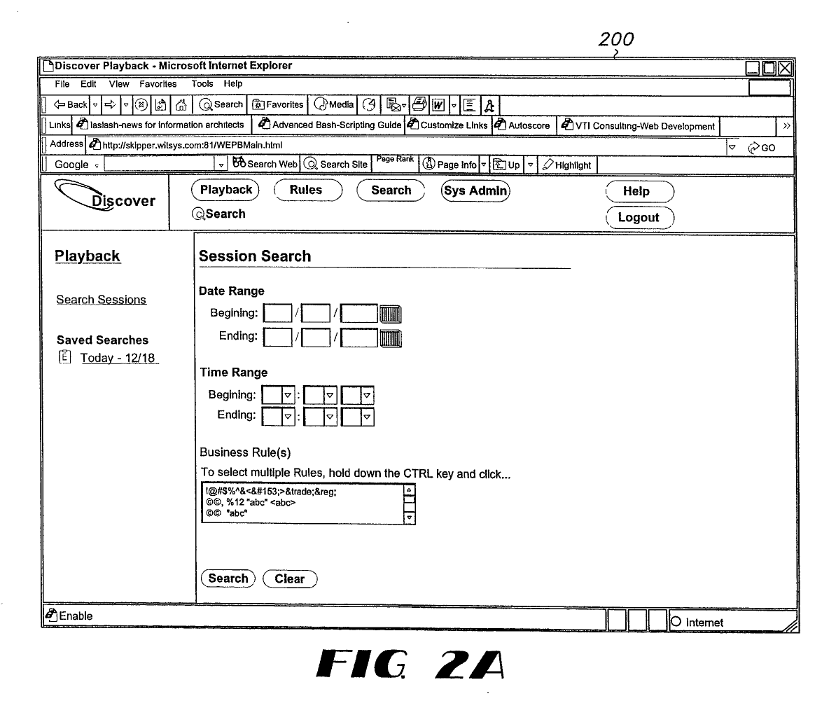

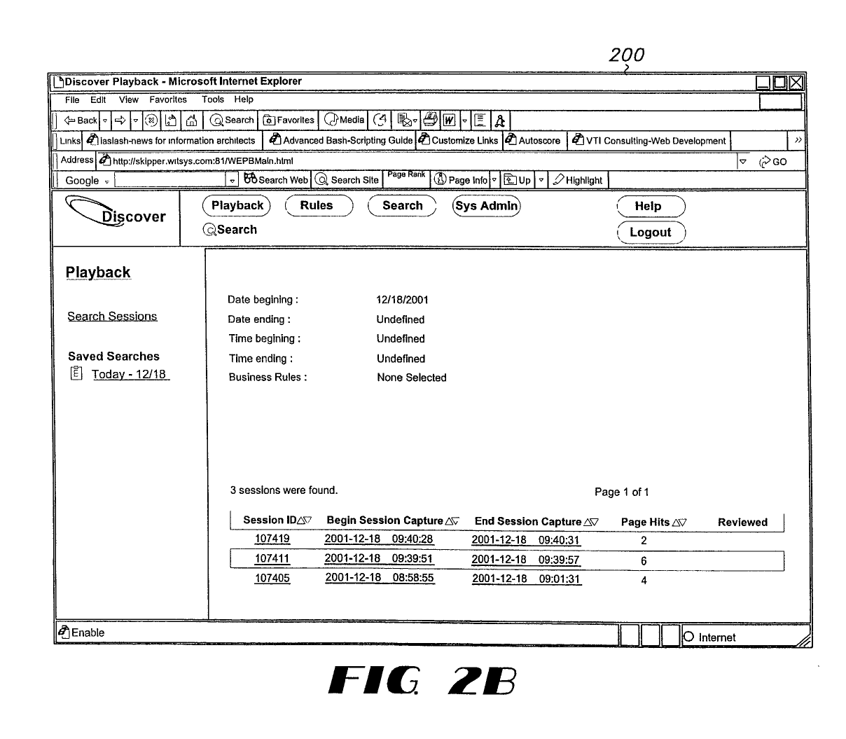

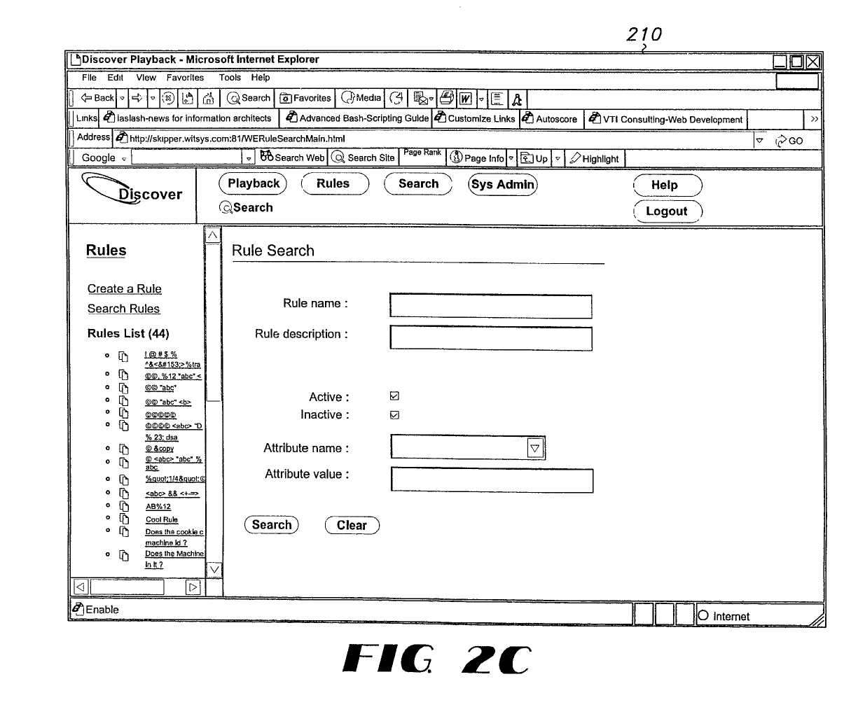

According to an exemplary embodiment, an exemplary search page layout 200 as shown in FIGS. 2A-2C may be used for searching. FIGS. 2A and 2B illustrate a search page 200, and FIG. 2C illustrates a rule search page 210.

The search page 200 is split into two screens, one of which is shown in FIG. 2A, and the other of which is shown in FIG. 2B. The search page screen shown in FIG. 2A allows the user to specify session search criteria. Session search criteria may include date/time criteria and rule criteria. Also, all captured pages may be searched for a specific machine ID. The screen shown in FIG. 2B illustrates the search parameters that are selected and the resulting sessions found based on the search parameters.

Date search criteria allow a user to find matching page captured sessions based on the begin/end date/time criteria. Date/time may be searched by entering, e.g., either a begin time or a begin and an end time. Rule criteria allows the user to find matching captured sessions based on business rules used to capture individual pages in a session. For instance, a user may wish to see all sessions that contain pages that were captured that satisfy business rule ID 0001 or business rule ID 0012. More than one business rule may be specified when performing searches by business rules.

The user may specify either the date/time criteria or the rule criteria or any combination of both. The date/time and rule criteria may be specified in the screen shown in FIG. 2A. Alternately, the rule criteria may be specified using the page 210 shown in FIG. 2C.

The results may be displayed in the screen shown in FIG. 2B. The results may be displayed as a tree view that may be expanded. Each top level tree node may be a hyperlink representing one row returned by the query. When a top level tree node is expanded, all matching pages for that node may be displayed.

The matching page information may be retrieved from the corresponding JAR file. The recorded pages for each top level tree node may be programmatically extracted from the corresponding JAR file. Each second level tree node may be a hyperlink to a recorded page. The selected recorded page may be displayed in a page display area, e.g., as described below. For pages that are recorded as frames, the parent frame may be displayed first.

To play back a session, a session is selected from a list of sessions based on the dates and rules provided. The selected session ID is retrieved, and the session ID is matched to a current machine ID.

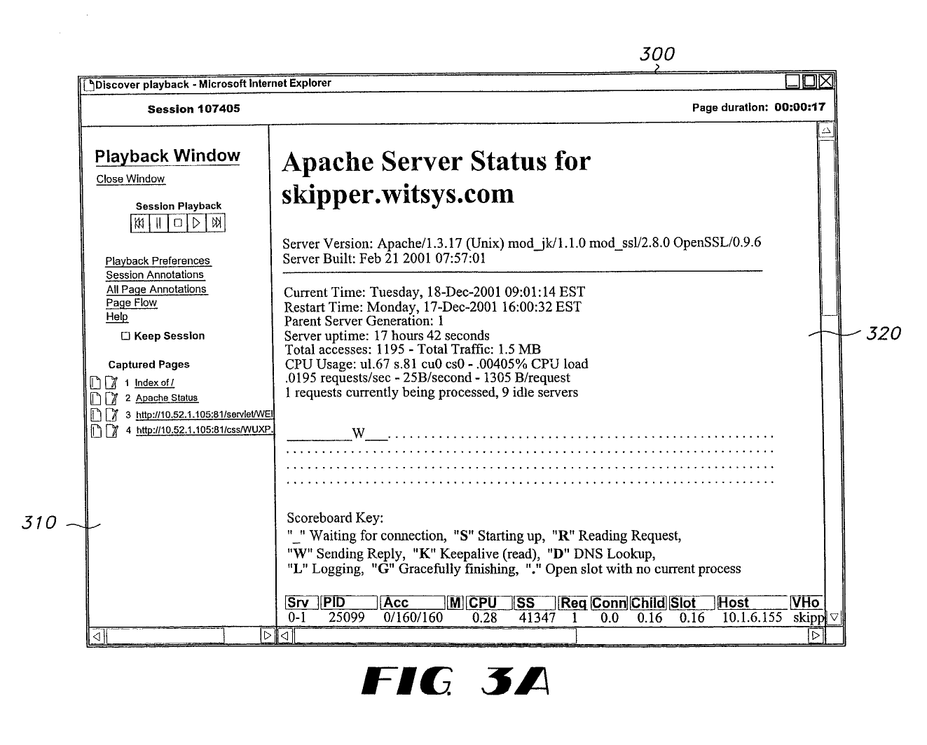

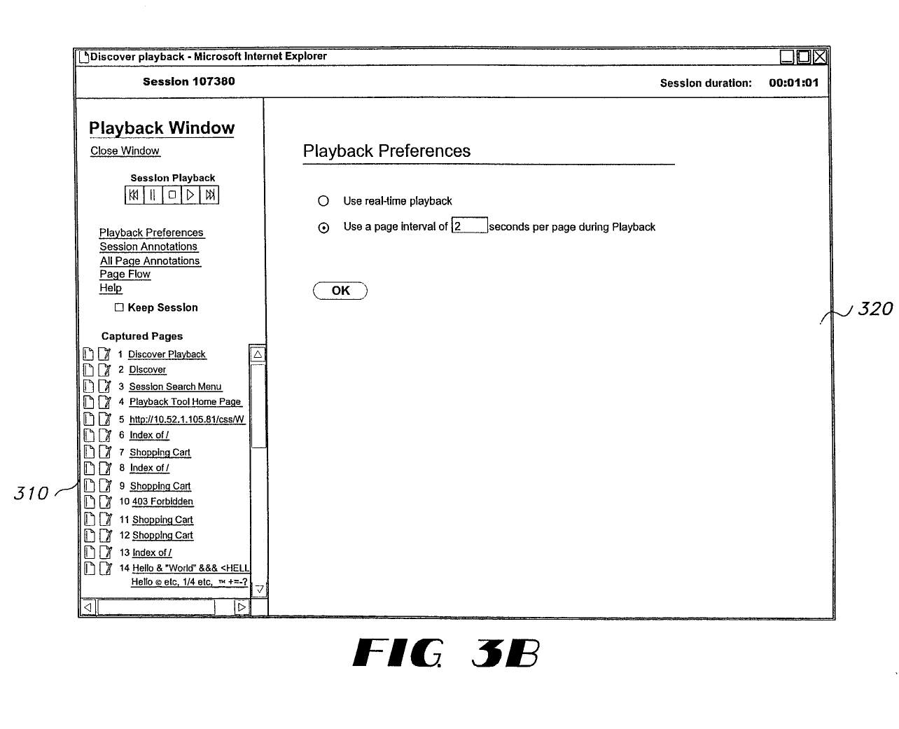

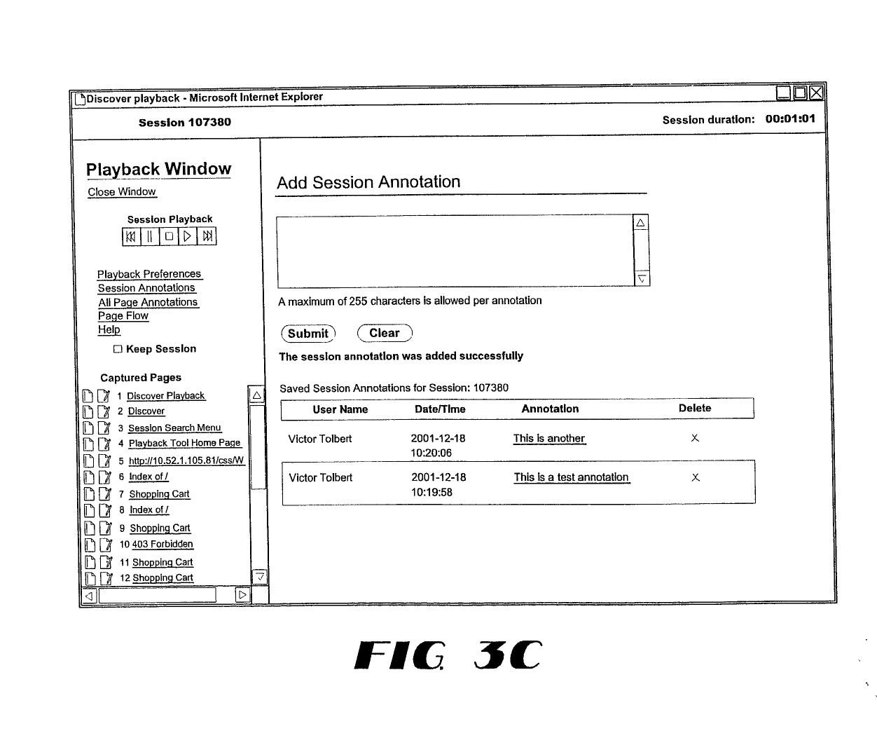

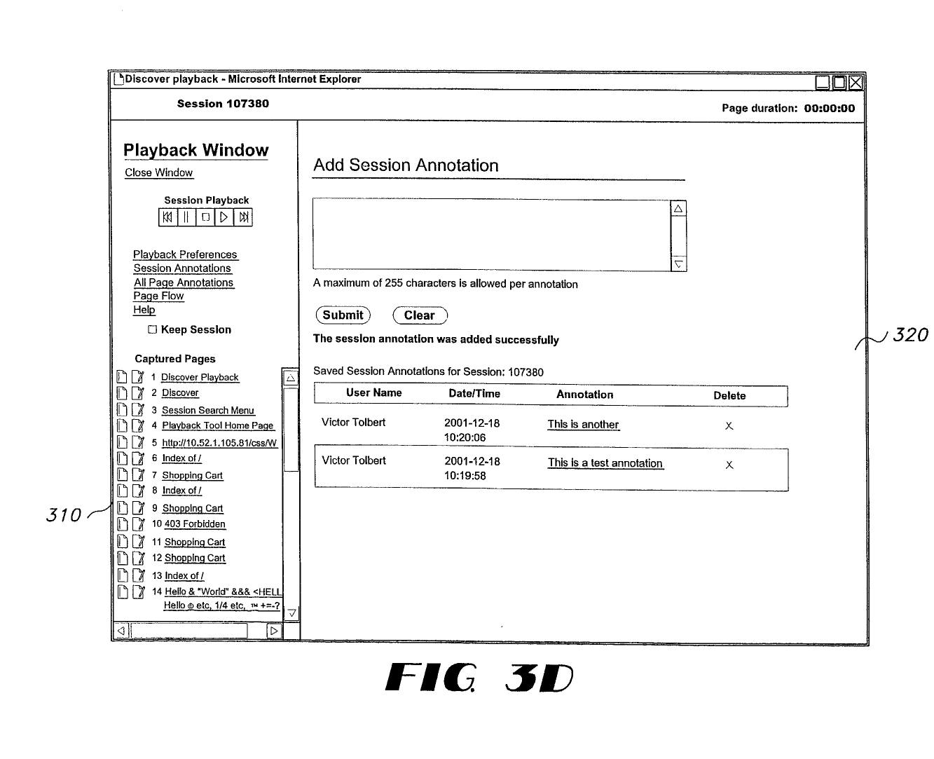

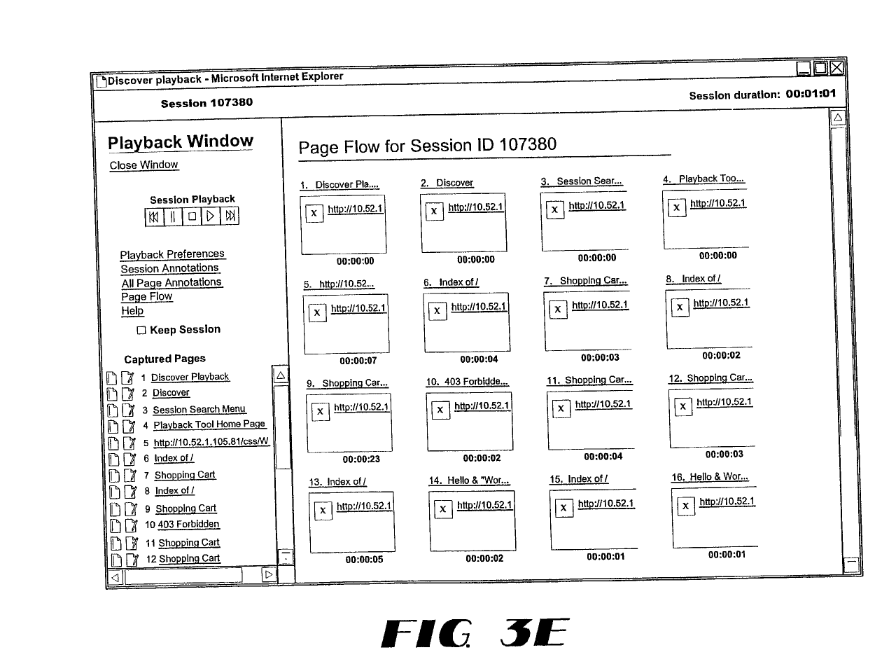

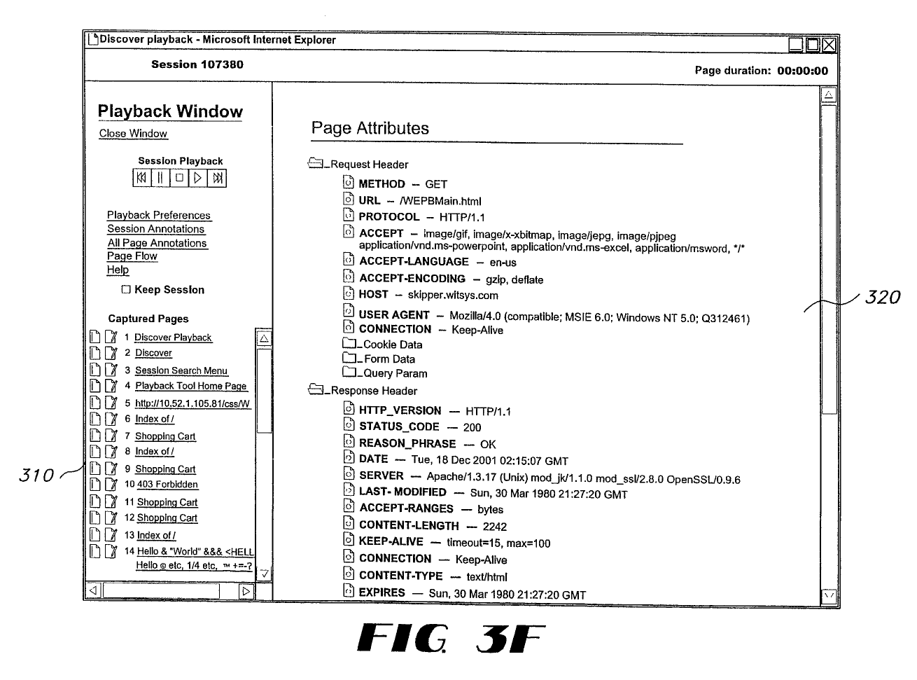

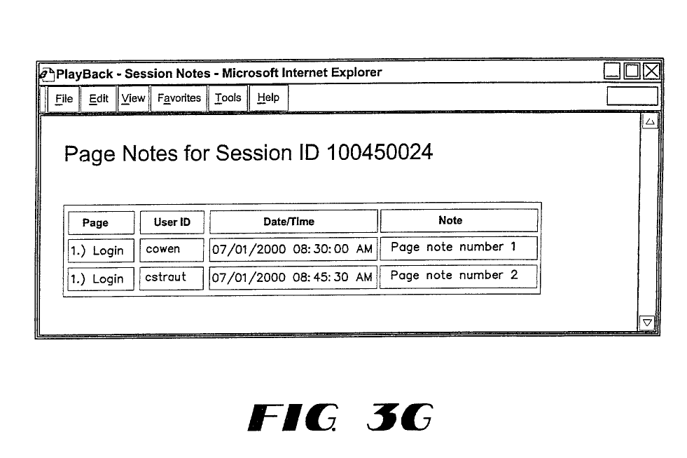

According to an exemplary embodiment, playback of a session may be handled using the playback page as shown in FIG. 3A. The playback page includes a playback control window 310 and a page display window 320. The playback page corresponds to a particular session. Fore example, the playback page shown in FIG. 3A corresponds to session “107405”.

As shown in FIG. 3A, the playback control window 310 includes a session playback control area, a session information area, and a detailed page information area.

The playback control area provides control using video cassette recorder (VCR) type button controls. The VCR type button control enables the user to move to the first captured page in a session, play the session, pause session and remain at current page, stop session playback and return to first page in session, and move to last captured page in session. Although not illustrated, a slider control may also be used, permitting the user to move from page to page, backward or forward by sliding the control to the left or to the right. Settings may be also be set to configure playback to run in a real-time mode or to use a specified page interval between pages during playback using, e.g., the playback preferences frame shown in FIG. 3B.

The session information area of the window 310 contains hyperlinks: playback preferences, sessions annotations, all page annotations, page flow, and help. Selecting one of these links causes the corresponding frame to be displayed. For example, selecting the hyperlink “Playback Preferences” causes the frame shown in FIG. 3B to be displayed which permits selection of real-time playback or page interval playback. Selecting the hyperlink “Session Annotations” causes the frame shown in FIG. 3C to be displayed, which allows session notes to be added and displays saved session notes for a particular session. Selecting “All page Annotations” causes the frame shown in FIG. 3D to be displayed, which permits page annotations to be added and displays saved annotations for a particular page. Selecting the hyperlink “Page Flow” causes the frame shown in FIG. 3E to be displayed, which illustrates thumbnails of captured pages. Selecting the hyperlink “Help” causes a help frame (not shown) to be displayed. Other hyperlinks may be used for playback control, as needed.

In the detailed page information area of window 310, a list of the captured pages in a session is displayed. Selecting one of the hyperlinks in the list causes the corresponding captured page to be displayed, e.g., in the window 320. For example, in FIG. 3A, the currently selected page (“Apache Status”) is shown in the window 320. Icons next to the hyperlinks may be used to display related information. For example, selecting the icon including a paper with a “!” causes the page attributes frame shown in FIG. 3F to be displayed, and selecting the icon including a paper and a pencil causes the pages notes frame shown in FIG. 3G to be displayed.

According to one embodiment, captured pages may be viewed sequentially, with the session of pages assembled in the order in which the pages occurred. Alternatively, the pages may be viewed in any order desired.

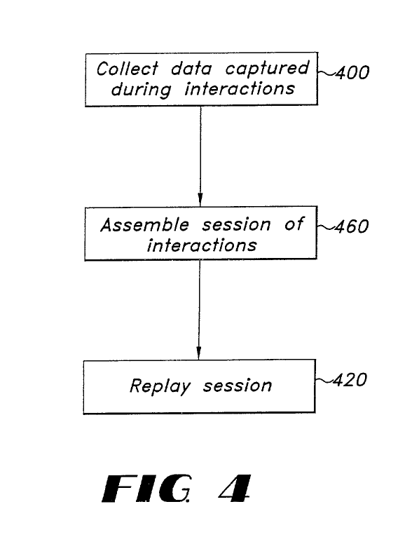

FIG. 4 illustrates a process for playing data according to an exemplary embodiment. The process begins at step 400 at which data captured during interaction between the user and the server during a given time period is collected. At step 410, a session of interactions is assembled din the order in which they occurred. This step may include searching a certain of a result set from which the session is assembled. At step 420, the session is replayed.

It should be understood that the foregoing description and accompanying drawings are by example only. A variety of modifications are envisioned that do not depart from the scope and spirit of the invention. The above description is intended by way of example only and is not intended to limit the present invention in any way.

What is claimed is:

1. A method for replaying data captured during at least one interaction between at least one server and at least one user, the method comprising the steps of:
collecting data captured during the interaction between the server and the user during a given time period;
assembling a session of interactions between the server and the user, including the at least one interaction, in the order in which they occurred; and
replaying the session.

2. The method of claim 1, further comprising:
searching for data that satisfies predetermined search criteria, among the captured data; and
creating a result set of data satisfying the search criteria, wherein the session is assembled from the result set.

3. The method of claim 2, wherein the step of searching searches among data selected from the captured data based upon predefined rules.

4. The method of claim 1, wherein the captured data includes at least one of pages, events, or attributes.

5. The method of claim 1, wherein the captured data is in the form of an Internet protocol, and the session is displayed as at least one web page to the user.

6. The method of claim 1, wherein the user is a web server or a web browser, and the server is a web server.

7. The method of claim 2, further comprising specifying the search criteria by the user.

8. The method of claim 2, wherein the search criteria includes a date and time range.

9. The method of claim 2, wherein the captured data is searched sequentially.

10. The method of claim 2, wherein the search criteria includes a specific user identification.

11. The method of claim 1, wherein the steps are performed for replaying data captured during interactions between a plurality of servers and the user, the server and a plurality of users, or a plurality of servers and a plurality of users.

12. An apparatus for replaying data captured during at least one interaction between at least one server and at least one user, the apparatus comprising:
means for collecting data captured during the interaction between the server and the user during a given time period;
means for assembling a session of interactions between the server and the user, including the at least one interaction, in the order in which they occurred; and
means for replaying the session.

13. The apparatus of claim 12, further comprising:
means for searching for data that satisfies predetermined search criteria among the captured data captured; and
means for creating a result set of data satisfying the predetermined search criteria, wherein the session is assembled from the result set.

14. The apparatus of claim 13, wherein the searching means searches among data selected from the captured data based upon predefined rules.

15. The apparatus of claim 12, wherein the captured data includes at least one of pages, events, or attributes.

16. The apparatus of claim 12, wherein the data is in the form of an Internet protocol, and the session is displayed as at least one web page to the user.

17. The apparatus of claim 12, wherein the user is a web browser or a web server, and the server is a web server.

18. The apparatus of claim 13, wherein the search criteria is specified by the user.

19. The apparatus of claim 13, wherein the search criteria includes a date and time range.

20. The apparatus of claim 13, wherein the captured data is searched sequentially.

21. The apparatus of claim 13, wherein the search criteria includes a specific user identification.

22. The apparatus of claim 12, wherein the apparatus replays data captured during interactions between a plurality of servers and the user, the server and a plurality of users, or a plurality of servers and a plurality of users.

23. A system for replaying captured data, comprising:
at least one server, at least one user,
a player for collecting data captured during at least one interaction between the server and the user during a given time period, assembling a session of interactions between the server and the user, including the at least one interaction, in the order in which they occurred, and replaying the session.

24. The system of claim 23, wherein the player searches for data that satisfies predetermined search criteria among the captured data, creates a result set of saved data satisfying the predetermined criteria, and assembles the session from the result set.

25. The system of claim 23, wherein the player searches among data selected from the captured data based upon predefined rules.

26. The system of claim 23, wherein the captured data includes at least one of pages, events, or attributes.

27. The system of claim 24, wherein the data is in the form of an Internet protocol, and the session is displayed as at least one web page to the user.

28. The system of claim 23, wherein the user is a web browser or a web server, and the server is a web server.

29. The system of claim 24, wherein the user specifies the search criteria.

30. The system of claim 24, wherein the search criteria includes a date and time range.

31. The system of claim 24, wherein the player searches the captured data sequentially.

32. The system of claim 24, wherein the search criteria includes a specific user identification.

33. The system of claim 23, wherein data captured during interactions between a plurality of servers and the user, the server and a plurality of users, or a plurality of servers and a plurality of users is replayed.
